(19) United States
(12) Patent Application Publication
(10) Pub. No.: US 2022/0101425 A1
(43) Pub. Date: Mar. 31, 2022

(54) PRODUCT PROVIDING METHOD, PRODUCT PROVIDING SERVER AND USER DEVICE

(71) Applicant: NEMONAN ORANGE CO., LTD., Seoul (KR)

(72) Inventor: Hye Mi AHN, Seoul (KR)

(73) Assignee: NEMONAN ORANGE CO., LTD., Seoul (KR)

(21) Appl. No.: 17/267,558

(22) PCT Filed: Jul. 8, 2019
(86) PCT No.: PCT/KR2019/008368

§ 371 Date: Feb. 10, 2021

(30) Foreign Application Priority Data
Aug. 2, 2018 (KR) 10-2018-0090289

(51) Int. Cl. G06Q 30/08; G06Q 20/12; G06Q 30/06; G06Q 10/08; G06Q 50/00; G06Q 30/02

(52) U.S. Cl. CPC G06Q 30/08; G06Q 20/12; G06Q 30/0635; G06Q 10/087; G06Q 50/01; G06Q 30/0282; G06Q 30/0631; G06Q 10/083

(57) ABSTRACT

A method for performing a product providing service by a product providing server includes receiving a purchase request for a product from a user device; proceeding with payment for the product; storing the product in an inventory corresponding to the user device; receiving a selection of a usage method made by the user device from a plurality of selectable usage methods for each product stored in the inventory; and providing each product based on the usage method selected by the user device, wherein the usage methods include a product delivery, an exchange with a product held by another user device and a point refund for at least one product.

### TECHNICAL FIELD

The present disclosure relates to a product providing method, a product providing server and a user device.

### BACKGROUND

Social commerce refers to e-commerce using social networks including social media and online/offline media. Social commerce can be classified into group buying type social commerce through which a certain number of people or more can buy products, social link-type social commerce that posts links to social networks, social web-type social commerce that combines consumers' activities, such as purchase, evaluation, review and the like, in social networks, and offline linked-type social commerce that is extended and linked to offline spaces.

Recently, there has been provided a platform that enables a user to exchange a product purchased by another user with a product purchased through social commerce. In this regard, Korean Patent Laid-open Publication No. 2015-0013374, which is a prior art, discloses a social sharing platform system, a social sharing platform providing apparatus, a method for providing the same, a mobile communication device, and a social sharing platform service method thereof.

### DISCLOSURE OF THE INVENTION

### Problems to be Solved by the Invention

In view of the foregoing, the present disclosure provides a product providing method, a product providing server and a user device by which a user purchases a random product and a product obtained as the random product is provided to an inventory corresponding to the user's account.

The present disclosure provides a product providing method, a product providing server and a user device by which a user can use a product obtained as a random product by selecting any one of a product delivery, an exchange with a product of another user and a refund as a point.

The present disclosure provides a product providing method, a product providing server and a user device by which, if a user wants to receive a delivery of a product, the product can be delivered in a bundle with other products stored in an inventory.

The present disclosure provides a product providing method, a product providing server and a user device by which, in case of a bundle delivery, the degree of possibility of a bundle delivery is notified to a user with a bundle delivery gauge and the user can change a combination for bundle delivery when checking the bundle delivery gauge.

However, the problems to be solved by the present disclosure are not limited to the above-described problems. There may be other problems to be solved by the present disclosure.

### Means for Solving the Problems

According to an aspect of the present disclosure, a method for performing a product providing service by a product providing server includes receiving a purchase request for a product from a user device; proceeding with payment for the product; storing the product in an inventory corresponding to the user device; receiving a selection of a usage method made by the user device from a plurality of selectable usage methods for each product stored in the inventory; and providing each product based on the usage method selected by the user device, wherein the usage methods include a product delivery, an exchange with a product held by another user device and a point refund for at least one product.

According to another aspect of the present disclosure, a product providing server that performs a product providing service includes a payment unit configured to receive a purchase request for a product from a user device and proceed with payment for the product; a product management unit configured to store the product in an inventory corresponding to the user device and receive a selection of a usage method from among a plurality of selectable usage methods for each product stored in the inventory; and a product providing unit configured to provide each product based on a usage method selected by the user device, wherein the usage methods include a product delivery, an exchange with a product held by another user device and a point refund for at least one product.

According to yet another aspect of the present disclosure, a method for receiving a product providing service by a user device, the method includes requesting a purchase of a product from a product providing server; proceed with payment for the product; selecting one of a plurality of selectable usage methods for each product stored in an inventory corresponding to the user device when the payment for the product is completed; transmitting the selected usage method to the product providing server, wherein the usage methods include a product delivery, an exchange with a product held by another user device and a point refund for each product.

The above-described aspects are provided by way of illustration only and should not be construed as liming the present disclosure. Besides the above-described embodiments, there may be additional embodiments described in the accompanying drawings and the detailed description.

### Effects of the Invention

According to any one of the above-described means for solving the problems of the present disclosure, it is possible to provide a product providing method, a product providing server and a user device by which a user purchases a random product and a product obtained as the random product is provided to an inventory corresponding to the user's account.

It is possible to provide a product providing method, a product providing server and a user device by which a user can use a product obtained as a random product by selecting any one of a product delivery, an exchange with a product of another user and a refund as a point.

It is possible to provide a product providing method, a product providing server and a user device by which, if a user wants to receive a delivery of a product, the product can be delivered in a bundle with other products stored in an inventory.

It is possible to provide a product providing method, a product providing server and a user device by which, in case of a bundle delivery, the degree of possibility of a bundle delivery is notified to a user with a bundle delivery gauge and the user can change a combination for bundle delivery when checking the bundle delivery gauge.

### BRIEF DESCRIPTION OF THE DRAWINGS

FIG. 1 is a diagram illustrating the configuration of a product providing system in accordance with an embodiment of the present disclosure.

FIG. 2 is a diagram illustrating the configuration of a product providing server in accordance with an embodiment of the present disclosure.

FIG. 3 is an exemplary diagram for describing a process for receiving a purchase request for a random product from a user device by a product providing server in accordance with an embodiment of the present disclosure.

FIG. 4 is an exemplary diagram for describing a process for storing a random product in an inventory corresponding to a user device by a product providing server in accordance with an embodiment of the present disclosure.

FIG. 5 is an exemplary diagram for describing a process for exchanging a product stored in an inventory of a user device with a product held by another user device by a product providing server in accordance with an embodiment of the present disclosure.

FIG. 6A to FIG. 6C are exemplary diagrams for describing a process for a bundle delivery of products stored in an inventory of a user device by a product providing server in accordance with an embodiment of the present disclosure.

FIG. 7A and FIG. 7B are exemplary diagrams for describing a process for providing a notification of winning a prize equal to or greater than a predetermined price through a first community by a product providing server in accordance with an embodiment of the present disclosure.

FIG. 8A to FIG. 8D are exemplary diagrams for describing a process for providing a ranking based on the purchase amount of a random product through a second community by a product providing server in accordance with an embodiment of the present disclosure.

FIG. 9A and FIG. 9B are exemplary diagrams for describing a process for receiving a recommendation on a product to be provided as a random product through a third community by a product providing server in accordance with an embodiment of the present disclosure.

FIG. 10 is a flowchart illustrating a method for performing a product providing service by a product providing server in accordance with an embodiment of the present disclosure.

FIG. 11 is a flowchart illustrating a method for receiving a product providing service by a user device in accordance with an embodiment of the present disclosure.

### BEST MODE FOR CARRYING OUT THE INVENTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, it is to be understood that the term “comprises or includes” and/or “comprising or including” used in the document means that one or more other components, steps, operation and/or existence or addition of elements are not excluded in addition to the described components, steps, operation and/or elements unless context dictates otherwise and is not intended to preclude the possibility that one or more other features, numbers, steps, operations, components, parts, or combinations thereof may exist or may be added.

Throughout this document, the term “unit” includes a unit implemented by hardware and/or a unit implemented by software. As examples only, one unit may be implemented by two or more pieces of hardware or two or more units may be implemented by one piece of hardware.

In the present specification, some of operations or functions described as being performed by a device may be performed by a server connected to the device. Likewise, some of operations or functions described as being performed by a server may be performed by a device connected to the server.

Hereinafter, an embodiment of the present disclosure will be described in detail with reference to the accompanying drawings.

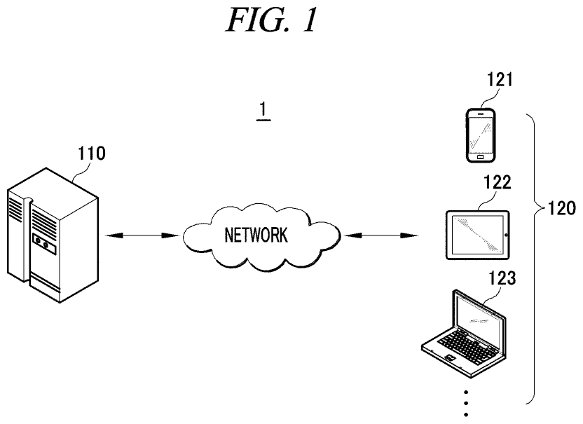

FIG. 1 is a diagram illustrating the configuration of a product providing system in accordance with an embodiment of the present disclosure. Referring to FIG. 1, a product providing system 1 may include a product providing server 110 and a user device 120. The product providing server 110 and the user device 120 illustrated in FIG. 1 are example components that can be controlled by the product providing system 1.

The components of the product providing system 1 illustrated in FIG. 1 are typically connected to each other via a network. For example, as illustrated in FIG. 1, a plurality of user devices 120 may be connected to the product providing server 110 simultaneously or sequentially.

The network refers to a connection structure that enables information exchange between nodes such as devices and servers. Examples of the network may include Wi-Fi, Bluetooth, Internet, LAN (Local Area Network), Wireless LAN (Wireless Local Area Network), WAN (Wide Area Network), PAN (Personal Area Network), 3G, 4G, 5G, LTE and the like, but are not limited thereto.

The product providing server 110 may receive a purchase request for a product from the user device 120 and proceed with payment for the product. Here, the product may be a random product, and the random product is a random box-type product and refers to a product that makes a user uncertain what he/she will get. The user may acquire any of various products by purchasing a random product. Here, any product to be acquired by the user may be randomly determined. Hereinafter, a description will be given on the assumption that the user device 120 purchases a random product, but may also be applied to the case where the user device 120 purchases a general product.

The product providing server 110 may determine at least one product to be provided to the user device 120 when payment for the random product is completed. Here, products are supplied by an advertiser and include, for example, goods, service vouchers, coupons and tokens, and a usage valid period may be set for some of the products. For example, the product providing server 110 may receive or directly purchase a predetermined quantity of products from an advertiser and provide the products to a first user device 121 until the products run out.

A method for registering a product in a product providing service by an advertiser will be briefly explained. The advertiser is a supplier who wants to get advertising effects by supplying products to the product providing service and may be a company and a group registered as a product supply member in the product providing service.

An advertisement server operated by the advertiser may be linked to the product providing server 110.

The advertisement server may register a predetermined quantity of products to be advertised in the product providing server 110. The product providing server 110 may advertise the products registered by the advertiser by exposing the products to an application and a site providing the product providing service. That is, the advertiser can expose the products to customers using the product providing service by supplying the products for free.

In this case, information about the advertiser (for example, a seller, a phone number, a website, etc.) may be exposed together with product information.

The product providing server 110 may expose the products until the products run out by being chosen as a random product. As such, by exposing the products until the products run out, it is possible to induce the advertiser to register a large quantity of products (because it takes longer time for a larger quantity of products to run out). Also, it is possible to induce the advertiser to register a high-priced product (because it takes longer time for a higher-priced product to run out due to a lower probability of winning).

When the products supplied by the advertiser run out of stock, the product providing server 110 may not expose all kinds of information including a description of the products and information about the seller and may transmit a message to notify the advertisement server that the products run out of stock and the products are not being exposed.

The product providing server 110 may store a product purchased by the user device 120 or at least one product determined as a random product in an inventory corresponding to the user device 120. The inventory includes an interface for product delivery, an interface for exchange and an interface for point refund for at least one product, and the interface for point refund includes information about a point and the point may be displayed with changes over time.

The product providing server 110 may receive a selection of a usage method made by the user device 120 from a plurality of selectable usage methods for each product stored in the inventory. Here, the usage methods may include a product delivery, an exchange with a product held by another user device and a point refund for at least one product.

The inventory will be briefly explained. The product providing server 110 may allocate and an inventory to each user device 120. For example, the product providing server 110 may create and allocate a first inventory corresponding to the first user device 121, a second inventory corresponding to a second user device 122, and a third inventory corresponding to a third user device 123.

The product providing server 110 may receive a selection of details of each usage method from the user device 120. For example, when the user device 120 selects a product delivery among the plurality of usage methods, the product providing server 110 may receive a selection of at least one product made by the user device 120 from a plurality of products stored in an inventory corresponding to the user device 120 and may also receive a selection of the quantity of each selected product.

After the payment for the product or the random product is completed in the user device 120, the product providing server 110 determines at least one product to be provided to the user device 120 and then provides the user device 120 with point refund information about the determined at least one product. The point refund information may include, for example, information about a point to be refunded for the at least one product. Here, the point may have a value lower than the value of the determined at least one product.

Here, the reason why the product providing server 110 provides the point refund information about the selected product is to induce the user to receive the product in the form of a point rather than in the form of goods through delivery or exchange.

This is because a large number of products need to be purchased and stored in advance to provide the selected product to the user in the form of goods, which may incur a lot of expense.

Also, since the value of the point to be refunded is lower than the value of the selected product, profit may be generated by the difference.

In addition, by inducing the user to receive the point refund for the corresponding product, it is possible to induce the user to purchase a random product by using the point and continue to use the product providing service.

The product providing server 110 may provide each product based on a usage method selected by the user device 120.

For example, when the user device 120 selects a product delivery among the plurality of usage methods, a selected product may be requested for delivery.

Here, the product providing server 110 may provide a bundle delivery function for a plurality of products. For example, a bundle delivery gauge is measured based on at least one of the volume, weight, hardness and price for at least one selected from a plurality of products stored in an inventory and the quantity of each product, and the selected at least one product may be requested for bundle delivery based on the bundle delivery gauge.

Here, the bundle delivery gauge is displayed as a bar gauge, and the gauge may be changed in real time based on a combination of at least one product selected by the user device 120 and the quantity of each product.

The reason for providing the bundle delivery function is that if the user using the product providing service receives various products in large quantities through repeated purchases of the product or the random product, the user must pay a delivery cost for each product, but the bundle delivery function enables the user to receive the products by paying a delivery cost only once.

Particularly, according to the product providing service of the present disclosure, if 1) a product or a product selected as a random product is stored in an inventory corresponding to the user's account and 2) the user registers the product as an exchange target product on a market platform but it is not exchanged for a long time, a large quantity of products are stored in the inventory. Here, the user wants the bundle delivery function. Therefore, in the present disclosure, the user can receive a large quantity of products through the bundle delivery function.

In general, a courier charges a basic rate for up to a certain weight and charges an extra cost when the package exceeds the weight limit. Here, if there is no limitation on the bundle delivery, the product providing server 110 may bear a lot of delivery costs. Therefore, in the present disclosure, limitations are imposed on the bundle delivery function through the bundle delivery gauge.

As another example, if the user device 120 selects an exchange with a product held by another user device among the plurality of usage methods, the product providing server 110 may receive, from the user device 120, a request to register the product stored in the inventory on the market platform and then register the product, as an exchange target product, on the market platform.

Thereafter, when the product providing server 110 receives, from another user device, an exchange request including information about an exchange-requested product held by the other user device, the product providing server 110 may transmit information about the exchange request to the user device 120.

Further, when the exchange request is accepted by the user device 120, the product providing server 110 moves the exchange-requested product to the inventory corresponding to the user device 120 and moves the exchange target product to an inventory corresponding to the other user device.

Here, the product providing server 110 not only displays the exchange target product through the market platform, but also receives all kinds of information including a description of the exchange target product and information about a seller (for example, a website and a phone number of an advertiser) and exposes the information with the exchange target product.

The product providing server 110 may determine a favorite product of a user corresponding to the first user device 121 based on product donation information, trade information through the market platform and SNS sharing information. In this case, when an exchange target product corresponding to the favorite product is registered on the market platform, the product providing server 110 may transmit information about the exchange target product corresponding to the registered favorite product to the first user device 121. As yet another example, if the user device 120 selects a point refund among the plurality of usage methods, the product providing server 110 may provide a point to an account corresponding to the user device 120. Here, the point may increase as a usage valid period of the product gets closer to expiration.

The product providing server 110 may provide a plurality of communities to a plurality of other user devices.

For example, the product providing server 110 may provide the plurality of other user devices with a first community including a notification of winning at least one product when the price of the at least one product is equal to or greater than a predetermined price. In this case, the plurality of other user devices may post replies to each notification.

As another example, the product providing server 110 may provide the plurality of other user devices with a second community including a ranking based on the purchase amount of a random product purchased by the user device 120 and the plurality of other user devices. In this case, the product providing server 110 may provide additional points to the user device 120 and the plurality of other user devices based on rankings of the user device 120 and the plurality of other user devices.

As yet another example, the product providing server 110 may provide the plurality of other user devices with a third community for receiving a recommendation on a product to be provided as a random product from the plurality of user devices 120.

The user device 120 may request a purchase of a product from the product providing server 110. Here, the product may be a random product.

The user device 120 may proceed with payment for the product or the random product.

When the payment for the product or the random product is completed, the user device 120 may select one of a plurality of selectable usage methods for each product determined by the product providing server 110 and stored in the inventory corresponding to the user device 120.

The user device 120 may transmit the selected usage method to the product providing server 11.

The user device 120 may include a wireless communication device 121 such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet), 3G, 4G and 5G devices and smart phone, and a tablet PC 122 such as a smart pad. In addition, the user device 120 may include all kinds of PCs 123 such as a desktop, a notebook, a netbook, a netbook, an ultrabook, a subnotebook, a desknote, a UMPC (Ultra-Mobile PC) and the like.

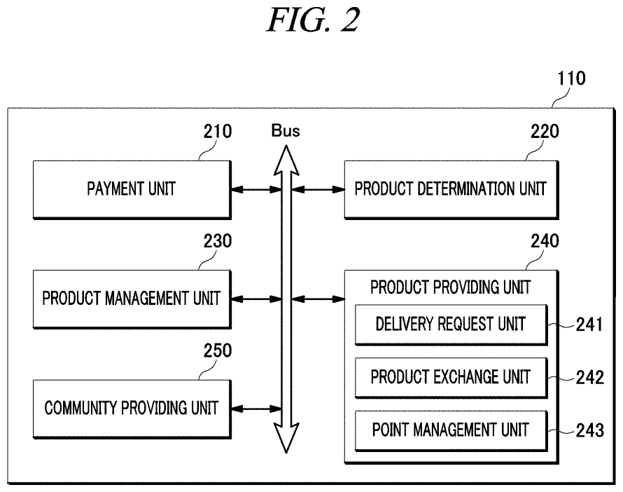

FIG. 2 is a diagram illustrating the configuration of a product providing server in accordance with an embodiment of the present disclosure. Referring to FIG. 2, the product providing server 110 may include a payment unit 210, a product determination unit 220, a product management unit 230, a product providing unit 240, and a community providing unit 250.

The payment unit 210 may receive a purchase request for a product from the user device 120 and proceed with payment for the product. Here, the product may be a random product.

When the payment for the random product is completed, the product determination unit 220 may determine at least one product to be provided to the user device 120. Here, a usage valid period may be set for the determined at least one product. For example, when the payment for the random product is completed, the product determination unit 220 may set a usage valid period of 15 days or 30 days for the product determined to be provided to the user device 120.

By setting a usage valid period for a product, for example, if the product is goods, the goods may be delivered or exchanged by the user within the usage valid period and may be refunded as a point by the user out of the usage valid period, which increases the likelihood of receiving a point refund rather than delivering or exchanging the product.

The product management unit 230 may store a product purchased by the user device 120 or at least one product determined as a random product in the inventory corresponding to the user device 120. The inventory includes an interface for product delivery, an interface for exchange and an interface for point refund for each product. Here, the interface for point refund includes information about a point and the point may be displayed with changes over time.

For example, if a user wants a point refund right after winning 5,000 won's worth of a product by purchasing a random product, a point for the product may be, for example, 2,500 points. Here, the point may be, for example 4,000 points as a usage valid period of the product is close to expiration. The reason for presenting a higher point for a product to the user as a usage valid period of the product gets closer to expiration is to induce the user to refund the product as a point rather than to receive the product in the form of goods through delivery or exchange.

Here, the product management unit 230 may periodically transmit, to the user device 120, a message to induce a point refund for the product stored in the inventory.

The product management unit 230 may receive a selection of a usage method made by the user device 120 from a plurality of selectable usage methods for each product stored in the inventory. Here, the usage methods may include a product delivery, an exchange with a product held by another user device and a point refund for at least one product.

The product management unit 230 may receive a selection of details of each usage method from the user device 120. For example, when the user device 120 selects a product delivery among the plurality of usage methods, the product management unit 230 may receive a selection of at least one product made by the user device 120 from a plurality of products stored in the inventory corresponding to the user device 120 and may also receive a selection of the quantity of each selected product.

After the payment for the product or the random product is completed in the user device 120, the product providing unit 240 determines at least one product to be provided to the user device 120 and then provides the user device 120 with point refund information about the determined at least one product. Here, the point refund information may include information about a point to be refunded for the at least one product.

The product providing unit 240 may provide each product based on the usage method selected by the user device 120. The product provider 240 may include a delivery request unit 241, a product exchange unit 242 and a point management unit 243.

When the user device 120 selects a product delivery among the plurality of usage methods, the delivery request unit 241 may receive a delivery request for a selected product.

Here, the delivery request unit 241 may provide a bundle delivery function for a plurality of products. For example, the delivery request unit 241 may measure a bundle delivery gauge based on at least one of the volume, weight, hardness and price for at least one selected from a plurality of products stored in an inventory and the quantity of each product, and request a bundle delivery of the selected at least one product based on the bundle delivery gauge.

For example, if the price of a product is equal to or smaller than a predetermined price (for example, 50,000 won), the delivery request unit 241 may measure a bundle delivery gauge in consideration of volume and weight. If the price of a product is greater than the predetermined price, the delivery request unit 241 may measure a bundle delivery gauge in consideration of hardness and price. Accordingly, it is possible to suppress damage to a high-priced product.

Here, the bundle delivery gauge is displayed as a bar gauge, and the gauge may be changed in real time based on a combination of at least one product selected by the user device 120 and the quantity of each product.

The maximum amount (for example, 100) of the bundle delivery gauge may be set by a manger of the product providing service. Here, a delivery gauge on the consumption amount may be set for each product. For example, a delivery gauge on the consumption amount may be set to 30 for a product A and a delivery gauge on the consumption amount may be set to 20 for a product B.

In this case, if the product A and the product B combined by the user device 120 are delivered, the consumption amount for a bundle delivery may be displayed through the bundle delivery gauge. For example, if two products A and two products B are combined, a bundle delivery gauge on the consumption amount is 100, and, thus, a bundle delivery is available. As another example, if one product A and three products B combined by the user device 120, a bundle delivery gauge on the consumption amount is 90, and, thus, a bundle delivery is available.

As another example, if the user device 120 selects an exchange with a product held by another user device among the plurality of usage methods, a request for registration of a product stored in the inventory on the market platform is received from the user device 120 and the product can be registered, as an exchange target product, on the market platform.

When the product exchange unit 242 receives, from another user device, information about an exchange-requested product held by the other user device and a request for an exchange of the exchange target product and the exchange-requested product, the product exchange unit 242 may transmit, to the user device 120, information about the exchange-requested product and information about the exchange request. When the exchange request is accepted by the user device 120, the product exchange unit 242 moves the exchange-requested product to the inventory corresponding to the user device 120 and moves the exchange target product to an inventory corresponding to the other user device.

Here, the product exchange unit 242 may receive an exchange request only for an exchange-requested product in the same price range as the exchange target product. Therefore, it is possible to suppress a senseless request for an exchange with a product in a different price range from another user device, which enables a reasonable product exchange between users. To this end, the product exchange unit 242 may filter a product (for example, a product in the same price range) that can be exchanged with a product held by the user and provide the product to the user device 120. By filtering out a product which cannot be exchanged through this filtering function, it is possible to facilitate an exchange of an exchange target product and an exchange-requested product.

When the exchange target product is not in the same price range as the exchange-requested product, the product exchange unit 242 may adjust the number of the exchange target product and the exchange-requested product to enable an exchange. For example, if the user device 120 registers an exchange target product “A” (5,000 won per each/having one piece) on the market platform, the product exchange unit 242 may adjust the number of exchange-requested products “B” (2,500 won per each/having four pieces) held by another user device to “two” to enable an exchange of the products “A” and “B”.

If the user device 120 selects a point refund among the plurality of usage methods, the point management unit 243 may provide information about a point. Here, the point may increase as a usage valid period gets closer to expiration.

The community providing unit 250 may provide a plurality of communities to a plurality of other user devices.

For example, the community providing unit 250 may provide a first community including a notification of winning at least one product when the price of the at least one product is equal to or greater than a predetermined price.

In general, when someone wins a high-priced product through a product providing service, other users tend to regard it as fabricated for promotional effect and not to believe the winning of the high-priced product. In this regard, the community providing unit 250 may notify that a user “A” has won a high-priced product through the first community, which can increase the reliability of the product providing service proposed by the present disclosure. Also, the users can be aware that they might also win a high-priced product and thus may be encouraged to actively purchase random products.

In this case, the plurality of other user devices may write replies to the notification.

Here, another user device may propose a product exchange by writing a reply. For example, the product exchange unit 242 may analyze a reply written by the other user device, extract information about a product held by the other user device from the reply and provide the information to the user device 120.

Also, the product exchange unit 242 may analyze the reply written by the other user device, extract information about the exchange-requested product registered on the market platform by the other user device and provide the information to the user device 120.

As another example, the community providing unit 250 may provide the plurality of other user devices with a second community including a ranking based on the purchase amount of a random product purchased by the user device 120 and the plurality of other user devices. Here, the community providing unit 250 may provide additional points to the user device 120 and the plurality of other user devices based on rankings of the user device 120 and the plurality of other user devices.

As yet another example, the community providing unit 250 may provide the plurality of other user devices with a third community for receiving a recommendation on a product to be provided as a random product from the plurality of user devices 120. The community providing unit 250 may count “likes” on the product to be provided as a random product input by the users through the third community and allow the product reflecting the user's preferences to be provided as a random product.

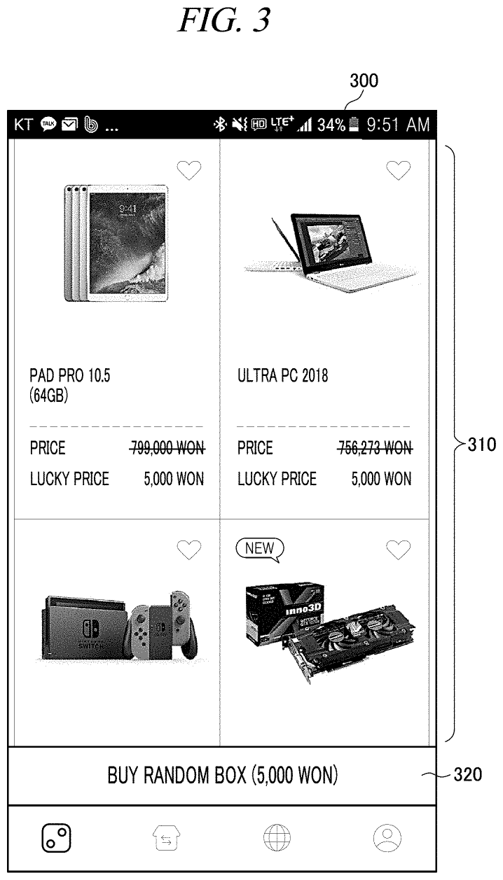

FIG. 3 is an exemplary diagram for describing a process for receiving a purchase request for a random product from a user device by a product providing server in accordance with an embodiment of the present disclosure. Referring to FIG. 3, the user device 120 may purchase a random product through an application that provides the product providing service.

The user device 120 may display, on a screen 300, a plurality of products 310 that can be provided as a random product through the application.

The user device 120 may select a “buy random box” tab 320 located at the bottom of the screen 300 to request a purchase of a random product from the product providing server 110.

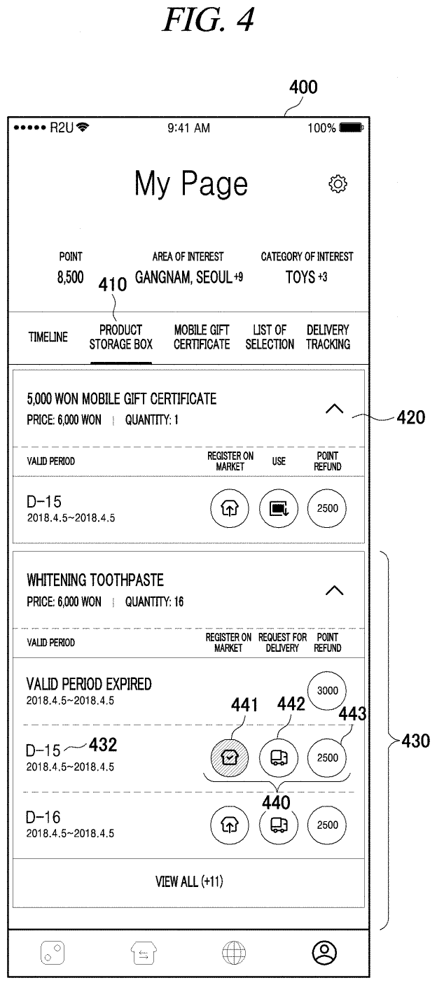

FIG. 4 is an exemplary diagram for describing a process for storing a random product in an inventory corresponding to a user device by a product providing server in accordance with an embodiment of the present disclosure. Referring to FIG. 4, when payment for the random product is completed, the product providing server 110 may determine a product to be provided to the user device 120 and store the product in an inventory corresponding to the user device 120.

The user device 120 may check the product corresponding to the random product through a “product storage box” 410 serving as an inventory corresponding to the user's account from a “my page” screen 400 of the application that provides the product providing service. Here, a usage valid period may be set for the product provided as the random product.

For example, the user device 120 may be provided with a “5,000 won mobile gift certificate” 420 as a random product from the product providing server 110, and a usage valid period may be set to “15 days” for the “5,000 won mobile gift certificate”.

As another example, the user device 120 may be provided with a “whitening toothpaste” 430 as a random product from the product providing server 110, and a usage valid period may be set to “16 days” for the “whitening toothpaste” 430.

The user device 120 may select any one of a plurality of usage methods for each random product stored in the “product storage box” 410. The plurality of usage methods may include, for example, an exchange 441 with a product held by another user device, a delivery 442 of a random product and a point refund 443. Here, in the point refund 443, the refund amount may increase as a usage valid period gets closer to expiration. For example, if 15 days or 16 days are left to expiration of the usage valid period, the point refund amount is 2,500 points, whereas if 0 days are left to expiration of the usage valid period, the point refund amount may increase to 4,000 points.

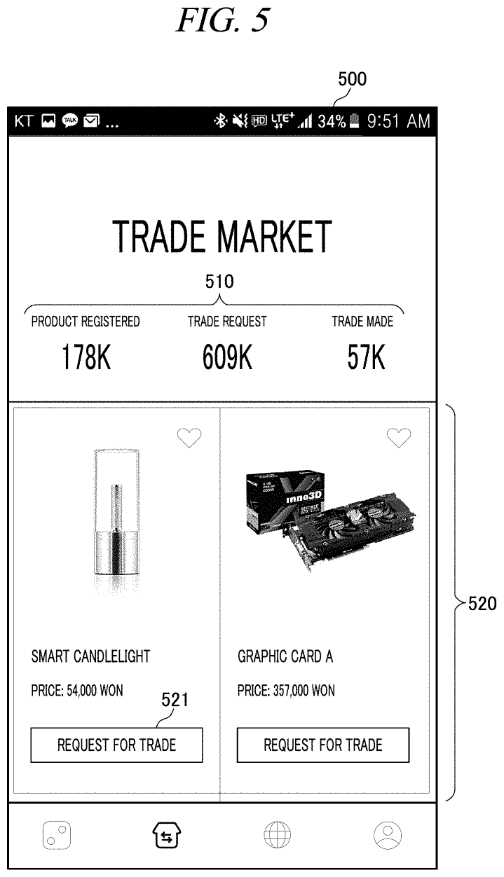

FIG. 5 is an exemplary diagram for describing a process for exchanging a product stored in an inventory of a user device with a product held by another user device by a product providing server in accordance with an embodiment of the present disclosure. Referring to FIG. 5, the user device 120 may register the random product stored in the inventory on the market platform and exchange the random product with a product held by another user device.

A market platform screen 500 may display the number of products registered on the market platform, the number of trade requests and the number of trades made 510 at the top of the screen, and display products 520 registered on the market platform at the bottom of the screen.

For example, when the user device 120 wants to exchange a product stored in the inventory with a product held by another user device, the user device 120 may select a “trade request” button 521 for a product registered by the other user device to request a product exchange from the other user device. The other user device may select one of acceptance, rejection and negotiation for the corresponding product exchange when the product exchange proceeds.

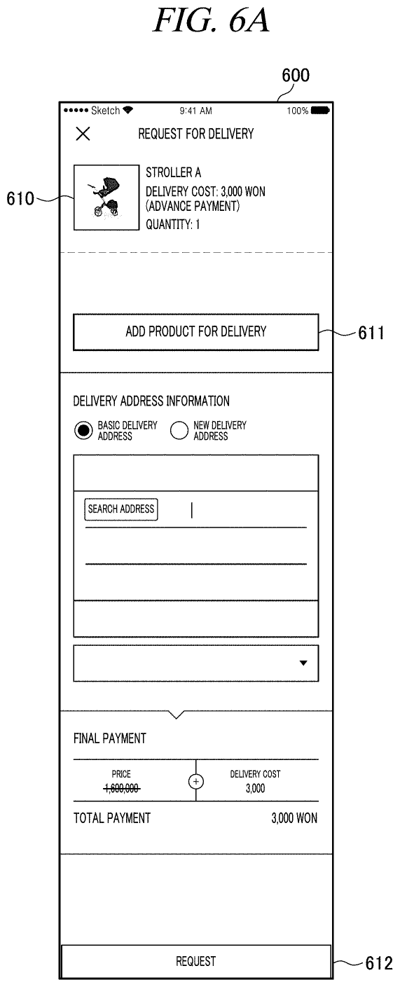

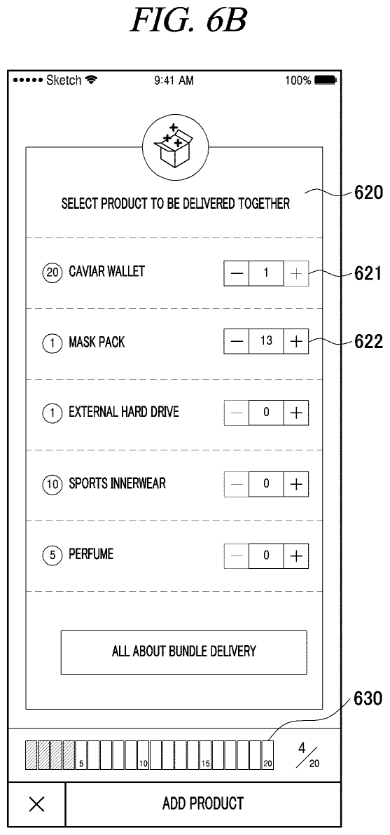

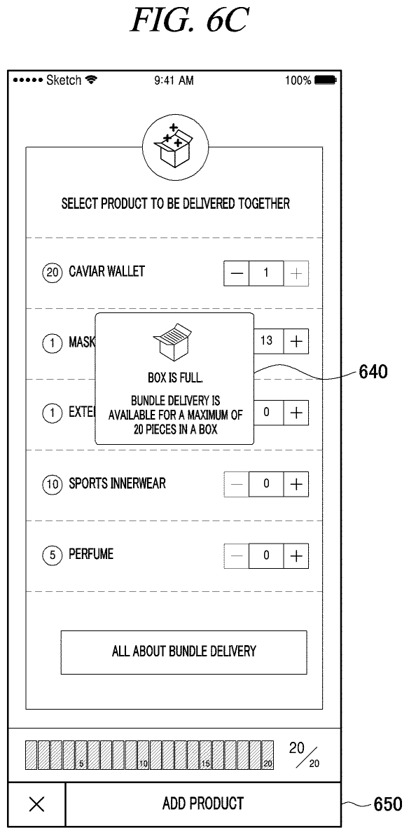

FIG. 6A to FIG. 6C are exemplary diagrams for describing a process for a bundle delivery of products stored in an inventory of a user device by a product providing server in accordance with an embodiment of the present disclosure.

FIG. 6A is an exemplary diagram illustrating a product delivery request screen in accordance with an embodiment of the present disclosure. Referring to FIG. 6A, the user device 120 may request a product delivery from the product providing server 110 by selecting a product delivery among the plurality of usage methods for the product stored in the inventory.

A product delivery request screen 600 may display a product 610 requested for delivery by the user device 120 and display delivery address information. The user device 120 may request a delivery of the product through a “request” button 612.

Here, if the user device 120 wants a bundle delivery with other products stored in the inventory, the user device 120 may request a bundle delivery with the other products from the product providing server 110 by selecting an “add product for delivery” button 611.

FIG. 6B is an exemplary diagram illustrating a bundle delivery request screen in accordance with an embodiment of the present disclosure. Referring to FIG. 6B, the user device 120 may request a bundle delivery from the product providing server 110 by selecting other products stored in the inventory.

A bundle delivery request screen 620 may display information about a plurality of other products stored in the inventory and may also display the number of each product. Here, whether a bundle delivery is available may be displayed through a bar-type bundle delivery gauge 630 based on the number of a product selected by the user. The bundle delivery gauge 630 may be displayed based on the volume, weight, hardness and price for a combination of the selected product and the quantity of the selected product.

For example, if a user selects one “caviar wallet” 621 and “thirteen” mask packs 622 from the other products stored in the inventory as products to be delivered in a bundle, the bundle delivery gauge 630 may be displayed as a bar gauge indicating that a combination of the selected products and the quantities of the respective products corresponds to 4/20.

FIG. 6C is an exemplary diagram illustrating a screen in which a bundle delivery gauge reaches the maximum value in accordance with an embodiment of the present disclosure. Referring to FIG. 6B and FIG. 6C, when the user selects another product stored in the inventory and the quantity of the product and a combination thereof reaches the maximum value of the bundle delivery gauges 630, a notification message such as “Box is full. Bundle delivery is available for a maximum of 20 pieces in a box” 640 may be displayed on the user device 120.

When the notification message is displayed, the user device 120 may request a bundle delivery of a combination selected through an “add product” button 650 from the product providing server 110. Here, the user may add a product by changing the combination of the product stored in the inventory and the quantity of the product.

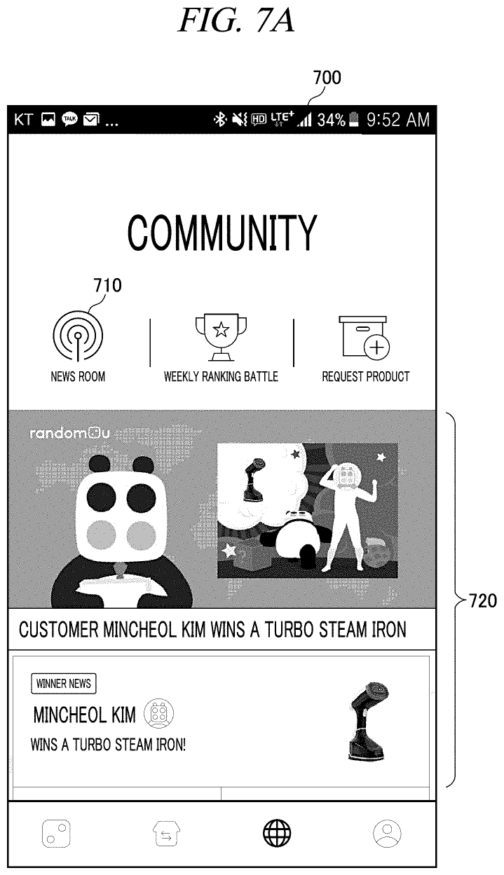

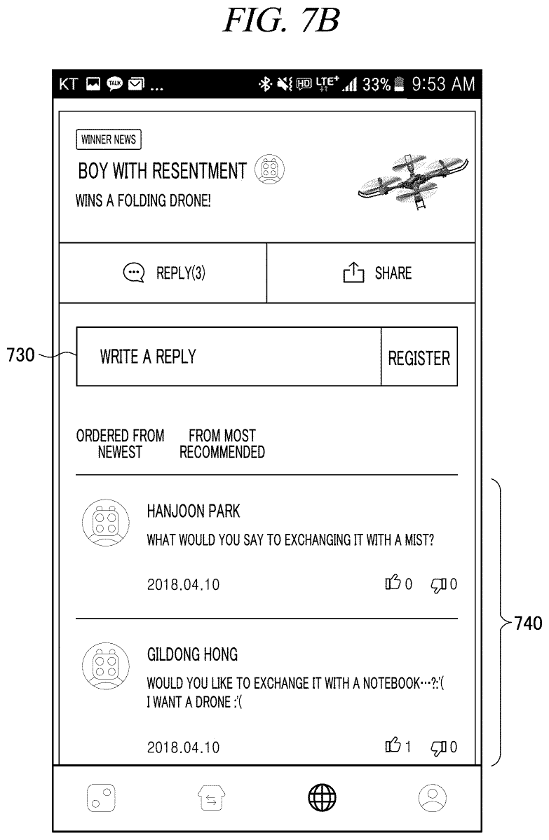

FIG. 7A and FIG. 7B are exemplary diagrams for describing a process for providing a notification of winning a prize equal to or greater than a predetermined price through a first community by a product providing server in accordance with an embodiment of the present disclosure.

FIG. 7A is an exemplary diagram illustrating a main screen of a first community in accordance with an embodiment of the present disclosure. Referring to FIG. 7A, the user device 120 may access a “newsroom” tab corresponding to a first community 710 through a community screen 700 of the application providing a random product.

When the price of the random product is equal to or greater than a predetermined price, the first community 710 may display a notification of winning a prize on the screen. For example, if a user named “Mincheol Kim” wins a steam iron as a random product, this is notified by the first community 710 through a winning news screen 720.

FIG. 7B is an exemplary diagram illustrating replies to a notification of winning a prize in accordance with an embodiment of the present disclosure. Referring to FIG. 7B, a plurality of other users may write replies 740 such as a congratulatory message through a reply box 730 located under a product notification screen.

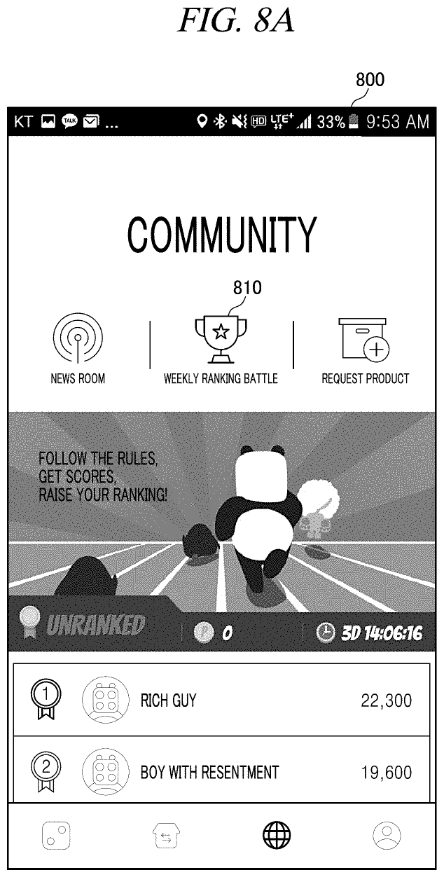

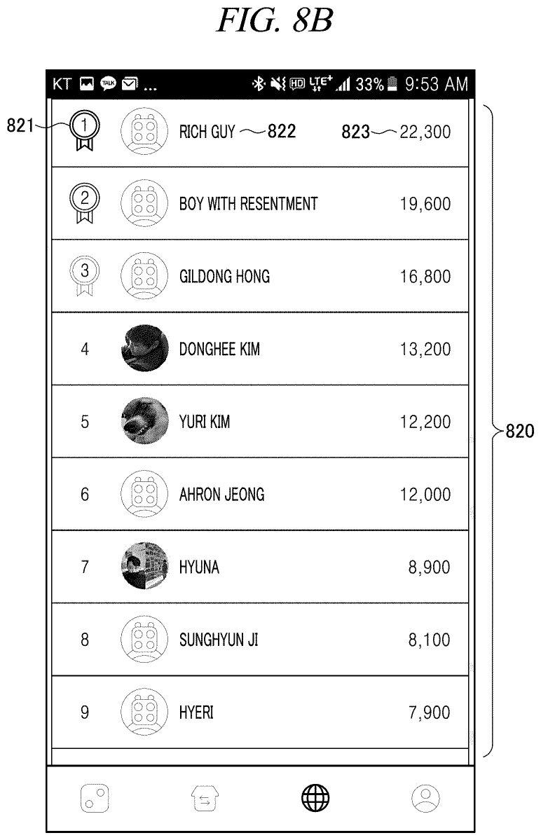

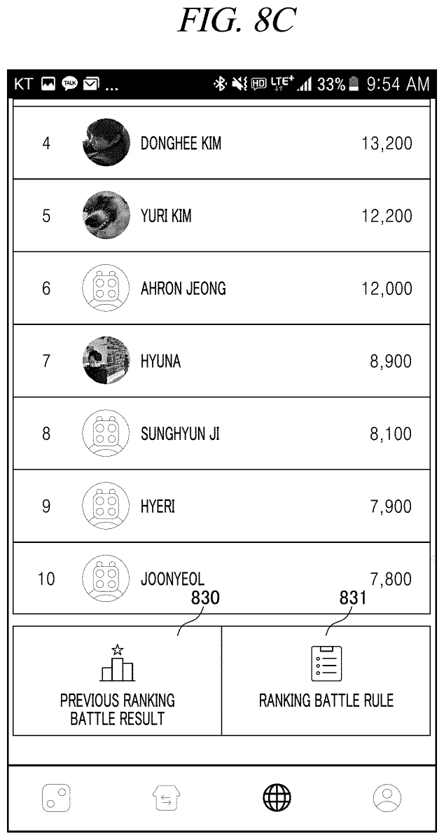

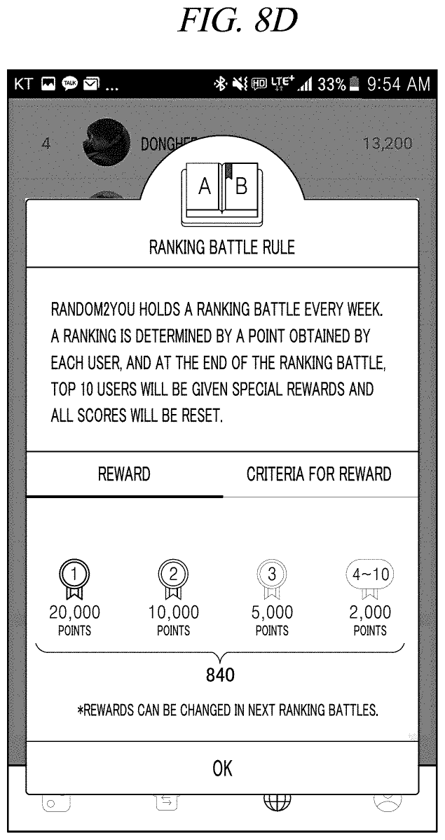

FIG. 8A to FIG. 8D are exemplary diagrams for describing a process for providing a ranking based on the purchase amount of a random product through a second community by a product providing server in accordance with an embodiment of the present disclosure.

FIG. 8A is an exemplary diagram illustrating a main screen of a second community in accordance with an embodiment of the present disclosure. Referring to FIG. 8A, the user device 120 may access a “weekly ranking battle” tab corresponding to a second community 810 through a community screen 800 of an application that provides a random product.

The second community 810 may display a ranking screen based on the purchase amount of a random product purchased by the user device 120 and the plurality of other user devices.

FIG. 8B is an exemplary diagram illustrating a ranking screen in accordance with an embodiment of the present disclosure. Referring to FIG. 8B, a ranking screen 820 may display a ranking 821, a nickname 822 corresponding to the ranking and a purchase amount 823 of a random product purchased by a user with the nickname 822.

FIG. 8C is an exemplary diagram illustrating information related to a ranking in accordance with an embodiment of the present disclosure. Referring to FIG. 8C, information related to the ranking may be provided by displaying a previous ranking battle result 830 and a ranking battle rule 831 at the bottom of the ranking screen.

FIG. 8D is an exemplary diagram illustrating ranking battle rule information in accordance with an embodiment of the present disclosure. Referring to FIG. 8D, the ranking battle rule information may include content 840 indicating a reward of additional points depending on a ranking. For example, the product information providing server 110 may give additional 20,000 points to first place, 10,000 points to second place, 5,000 points to third place and 2,000 points to fourth to tenth places.

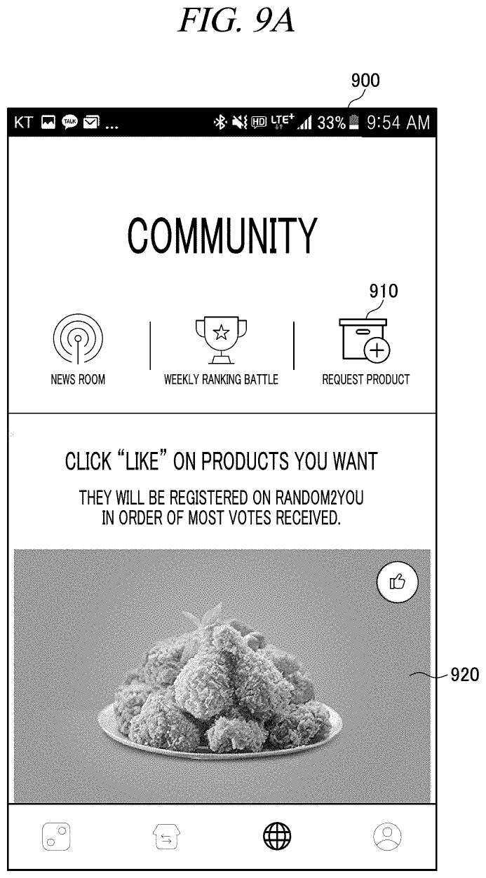

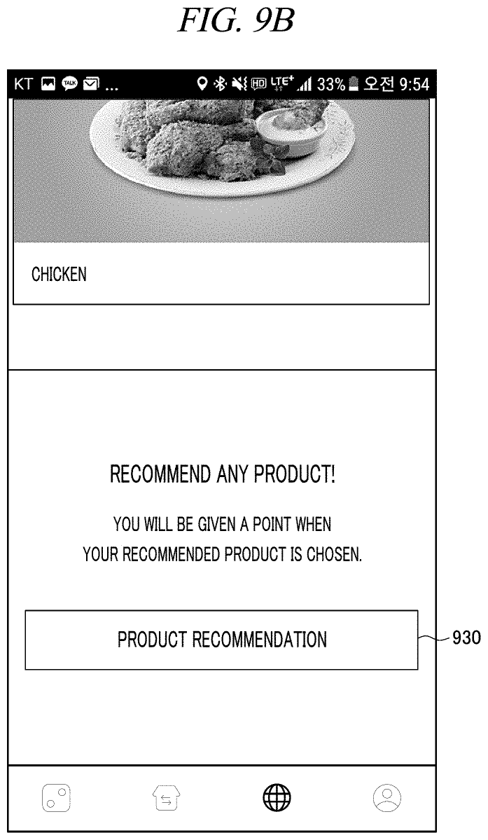

FIG. 9A and FIG. 9B are exemplary diagrams for describing a process for receiving a recommendation on a product to be provided as a random product through a third community by a product providing server in accordance with an embodiment of the present disclosure.

FIG. 9A is an exemplary diagram illustrating a main screen of a third community in accordance with an embodiment of the present disclosure. Referring to FIG. 9A, the user device 120 may access a “product request” tab corresponding to a third community 910 through a community screen 900 of the application that provides a random product.

The third community 910 may display a product 920 to be provided as a random product and receive a recommendation on the product from the plurality of user devices 120.

FIG. 9B is an exemplary diagram illustrating a product recommendation button in accordance with an embodiment of the present disclosure. Referring to FIG. 9B, when the user device 120 wants the product to be provided as a random product, the user device 120 may select a “product recommendation” tab 930 for the product to recommend the product.

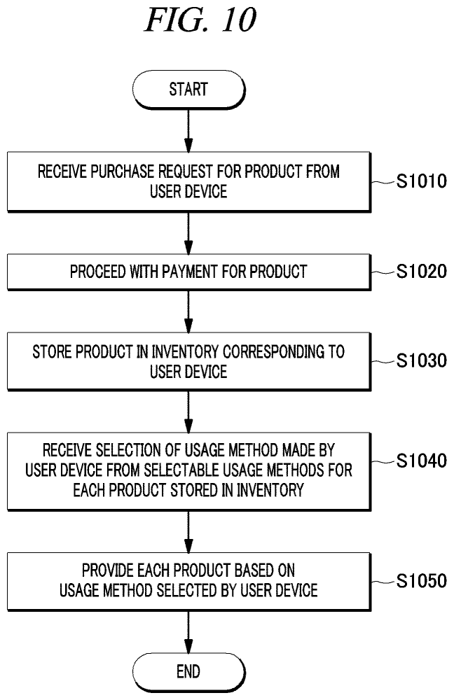

FIG. 10 is a flowchart illustrating a method for performing a product providing service by a product providing server in accordance with an embodiment of the present disclosure. A method for providing a product providing service by the product providing server 110 according to the embodiment illustrated in FIG. 10 includes the processes time-sequentially performed by the product providing system 1 according to the embodiment illustrated in FIG. 1. Therefore, descriptions of the processes performed by the product providing system 1 may be applied to the method of providing a product providing service by the product providing server 110 according to the embodiment illustrated in FIG. 1 to FIG. 9B, even though they are omitted hereinafter.

In a process S1010, the product providing server 110 may receive a purchase request for a product from the user device 120.

In a process S1020, the product providing server 110 may proceed with payment for the product.

In a process S1030, the product providing server 110 may store the product in an inventory corresponding to the user device 120.

In a process S1040, the product providing server 110 may receive a selection of a usage method made by the user device 120 from a plurality of selectable usage methods for each product stored in the inventory.

In a process S1050, the product providing server 110 may provide each product based on the usage method selected by the user device 120.

In the descriptions above, the processes S1010 to S1050 may be divided into additional processes or combined into fewer processes depending on an embodiment. In addition, some of the processes may be omitted and the sequence of the processes may be changed if necessary.

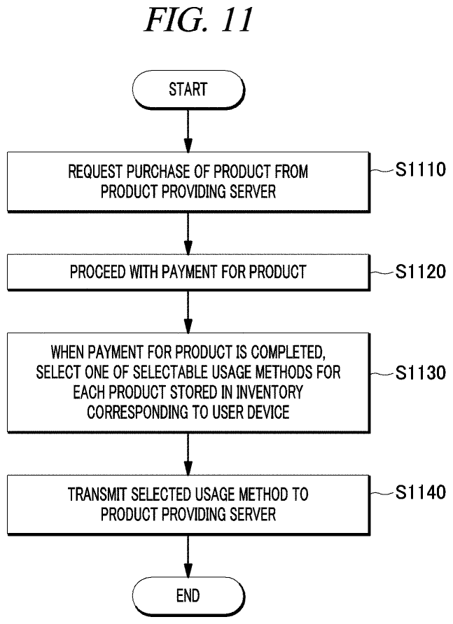

FIG. 11 is a flowchart illustrating a method for receiving a product providing service by a user device in accordance with an embodiment of the present disclosure. The method for receiving a product providing service by the user device 120 according to the embodiment illustrated in FIG. 11 includes the processes time-sequentially performed by the product providing system 1 according to the embodiment illustrated in FIG. 1. Therefore, descriptions of the processes performed by the product providing system 1 may be applied to the method of receiving a product providing service by the user device 120 according to the embodiment illustrated in FIG. 1 to FIG. 10, even though they are omitted hereinafter.

In a process S1110, the user device 120 may request a purchase of a product from the product providing server 110.

In a process S1120, the user device 120 may proceed with payment for the product.

In a process S1130, when the payment for the product is completed, the user device 120 may select one of a plurality of selectable usage methods for each product stored in the inventory corresponding to the user device 120.

In a process S1140, the user device 120 may transmit the selected usage method to the product providing server 110.

In the descriptions above, the processes S1110 to S1140 may be divided into additional processes or combined into fewer processes depending on an embodiment. In addition, some of the processes may be omitted and the sequence of the processes may be changed if necessary.

The method for providing the product providing service by the product providing server and the method for receiving the product providing service by the user device through a game as described above with reference to FIG. 1 to FIG. 11 can be implemented as a computer program stored in a medium to be executed by a computer or a storage medium including instructions executable by a computer. Also, the method for providing the product providing service by the product providing server and the method for receiving the product providing service by the user device through a game as described above with reference to FIG. 1 to FIG. 11 can be implemented as a computer program stored in a medium to be executed by a computer. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A method for performing a product providing service by a product providing server, comprising:
receiving a purchase request for a product from a user device;
proceeding with payment for the product;
storing the product in an inventory corresponding to the user device;
receiving a selection of a usage method from among a plurality of selectable usage methods for each product stored in the inventory; and
providing each product based on a usage method selected by the user device,
wherein the usage methods include a product delivery, an exchange with a product held by another user device and a point refund for at least one product.

2. The product providing method of claim 1, further comprising:
if the product delivery is selected from the usage methods,
receiving a selection of at least one product from among a plurality of products stored in the inventory corresponding to the user device; and
receiving a selection of the quantity of each selected product.

3. The product providing method of claim 2, further comprising:
measuring a bundle delivery gauge based on at least one of the volume, weight, hardness and price for a combination of the selected at least one product and the quantity of each product; and
providing the selected at least one product by bundle delivery based on the bundle delivery gauge.

4. The product providing method of claim 3,
wherein the bundle delivery gauge is displayed as a bar gauge, and
the gauge is changed in real time based on the combination of the at least one product and the quantity of each product selected by the user device.

5. The product providing method of claim 1,
wherein the product is a random product, and
after the proceeding with payment for the product,
the method further includes determining at least one product to be provided to the user device when the payment for the product is completed.

6. The product providing method of claim 5, further comprising:
after determining at least one product to be provided to the user device when the payment for the product is completed,
the method further includes providing the user device with point refund information about the determined at least one product,
wherein the point refund information includes information about a point to be refunded for the at least one product.

7. The product providing method of claim 6,
wherein a usage valid period is set for the determined at least one product, and
the point increases as the usage valid period gets closer to expiration.

8. The product providing method of claim 7,
wherein the inventory includes an interface for the product delivery, an interface for the exchange and an interface for the point refund for the determined at least one product, and
the interface for the point refund includes information about the point and the point is displayed with changes over time.

9. The product providing method of claim 6, further comprising:
providing a plurality of other user devices with a first community including a notification of winning the determined at least one product when the price of the determined at least one product is equal to or greater than a predetermined price.

10. The product providing method of claim 9,
wherein the plurality of other user devices is able to write replies to the notification.

11. The product providing method of claim 6, further comprising:
providing the plurality of other user devices with a second community including a ranking based on the purchase amount of the random product purchased by the user device and the plurality of other user devices.

12. The product providing method of claim 11, further comprising:
providing additional points to the user device and the plurality of other user devices based on rankings of the user device and the plurality of other user devices.

13. The product providing method of claim 6, further comprising:
providing the plurality of other user devices with a third community for receiving a recommendation on a product to be provided as the random product from a plurality of user devices.

14. The product providing method of claim 1, further comprising:
if the exchange with the product held by the another user device is selected from the usage methods,
receiving, from the user device, a request for registration of a product stored in the inventory on a market platform;
registering the product as an exchange target product on the market platform;
a receiving, from the other user device, information about an exchange-requested product held by the other user device and a request for an exchange of the exchange target product and the exchange-requested product;
transmitting, to the user device, the information about the exchange-requested product and the request for the exchange; and
if the request for the exchange is accepted, moving the exchange-requested product to the inventory corresponding to the user device and moving the exchange target product to an inventory corresponding to the other user device.

15. A product providing server that performs a product providing service, comprising:
a payment unit configured to receive a purchase request for a product from a user device and proceed with payment for the product;
a product management unit configured to store the product in an inventory corresponding to the user device and receive a selection of a usage method from among a plurality of selectable usage methods for each product stored in the inventory; and
a product providing unit configured to provide each product based on a usage method selected by the user device,
wherein the usage methods include a product delivery, an exchange with a product held by another user device and a point refund for at least one product.

16. The product providing server of claim 15,
wherein the product is a random product, and
the product providing server further includes a product determination unit configured to determine at least one product to be provided to the user device after the payment for the product is completed.

17. A method for receiving a product providing service by a user device, the method comprising:
requesting a purchase of a product from a product providing server;
proceed with payment for the product;
selecting one of a plurality of selectable usage methods for each product stored in an inventory corresponding to the user device when the payment for the product is completed;
transmitting the selected usage method to the product providing server,
wherein the usage methods include a product delivery, an exchange with a product held by another user device and a point refund for each product.
